(19) United States
(12) Patent Application Publication
(10) Pub. No.: US 2010/0249259 A1
(43) Pub. Date: Sep. 30, 2010

(54) HARD FOAM

(75) Inventors: Tatsuo Kaneko, Ishikawa (JP); Takanori Ishikura, Ishikawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN ADVANCED INSTITUTE OF SCIENCE AND TECHNOLOGY, Nomi-shi, Ishikawa (JP)

(21) Appl. No.: 12/739,274

(22) PCT Filed: Oct. 18, 2008
(86) PCT No.: PCT/JP2008/002960

§ 371 Date: Apr. 22, 2010

(30) Foreign Application Priority Data
Oct. 25, 2007 (JP) 2007-277167

(51) Int. Cl. C08G 63/06

(52) U.S. Cl. 521/147

(57) ABSTRACT

A hard foam formed from a carboxylic acid ester-based polymer having a ring structure, the hard foam being obtained by heating the carboxylic acid ester-based polymer having a ring structure to generate a gaseous organic acid from the carboxylic acid ester-based polymer, and foaming the heated carboxylic acid ester-based polymer with the gaseous organic acid, and a method for producing the same. The hard foam can be used as various heat insulating materials, various vibration isolators, various acoustic materials, various soundproof materials and the like. Therefore, the hard foam is expected to be used for automobile component materials, materials for airplanes, materials for the space field, materials for industries, materials for medical assistance, and the like.

### TECHNICAL FIELD

The present invention relates to hard foams. More particularly, the present invention relates to a hard foam and a method for producing the same. Hard foams are useful for, for example, automobile component materials; materials for airplanes, such as heat insulating materials and acoustic blankets for fuselages, heat insulating materials of air-conditioning ducts, vibration isolators of fuselages, heat insulating materials and vibration isolators of loaded instruments; materials for the space field, such as heat insulating materials of tanks for propellants of rockets, acoustic materials of fairings, heat insulating materials of the surfaces of satellite thermal louvers, heat insulating materials of cryogenic tanks, and heat insulating materials of reentry ablators; materials for various industries, such as heat insulating acoustic materials of automobile engines, and heat insulating acoustic materials in nuclear power plants; and materials for medical assistance, such as soundproof materials of housings of medical instruments and building materials for heat and sound insulation of hospitals.

### BACKGROUND ART

Resin foams have hitherto been produced by foaming a resin with a foaming agent such as a low-boiling compound. From the viewpoint of global environmental protection in the earth, it has recently been proposed to produce a resin foam without using any foaming agent. As a resin foam free of any foaming agent, there have been proposed a foam produced by foaming a self-foaming composition containing a perfluoropolymer and a foam nucleating agent (see, for example, Patent Document 1), and a cured material obtained by self-foaming and curing a self-foaming, heat-curable liquid silicone rubber composition containing an organopolysiloxane (see, for example, Patent Document 2).

However, the former foam has a drawback such that carbon dioxide gas, which is considered to be a cause of global warming, is generated during the production of the foam, because foaming is carried out by decarboxylating a terminal group of the perfluoro polymer in its production stage. The latter cured material has a drawback such that carbon dioxide gas, which is considered to be a cause of global warming, is generated during the production of the foam, because an organic peroxide is used as a compound for foaming as well as the former foam, and this organic peroxide is decomposed upon heating, to generate carbon dioxide gas.

Accordingly, in recent years, it has been desired to develop a hard foam without the generation of carbon dioxide gas during its production.

Patent Document 1: Japanese Unexamined Patent Publication No. Hei10-195216

Patent Document 2: Japanese Unexamined Patent Publication No. 2004-292687

### DISCLOSURE OF THE INVENTION

### Problems to be Solved by the Invention

The present invention has been accomplished in view of the above-mentioned prior art. An object of the present invention is to provide a hard foam which is produced without the generation of carbon dioxide gas, which is excellent in heat resistance, and which has high mechanical strength.

### Means for Solving the Problems

The present invention relates to:

[1] a hard foam formed from a carboxylic acid ester-based polymer having a ring structure, the hard foam being obtained by heating a carboxylic acid ester-based polymer having a ring structure to generate a gaseous organic acid from the carboxylic acid ester-based polymer, and foaming the heated carboxylic acid ester-based polymer with the gaseous organic acid; and
[2] a method for producing a hard foam formed from a carboxylic acid ester-based polymer having a ring structure, comprising heating a carboxylic acid ester-based polymer having a ring structure to generate a gaseous organic acid from the carboxylic acid ester-based polymer, and foaming the heated carboxylic acid ester-based polymer with the gaseous organic acid.

### EFFECT OF THE INVENTION

The hard foam of the present invention is produced without the generation of carbon dioxide gas which is considered to be a cause of global warming. The hard foam of the present invention is excellent in heat resistance and has high mechanical strength. According to the method of the present invention for producing a hard foam, it is possible to produce a hard foam which is excellent in heat resistance and has high mechanical strength without the generation of carbon dioxide gas which is considered to be a cause of global warming.

### BRIEF DESCRIPTION OF THE DRAWINGS

FIG. 1 A graph showing an infrared absorption spectrum of poly(ferulic acid) obtained in Example 1 of the present invention.

FIG. 2 A graph showing a nuclear magnetic resonance spectrum of poly(ferulic acid) obtained in Example 1 of the present invention.

FIG. 3 A scanning electron microscope (SEM) photograph taken in a cross section of the hard foam obtained in Example 2 of the present invention.

FIG. 4 A graph showing the differentially scanned calorimetric variation by heating the hard foam obtained in Example 5 of the present invention.

FIG. 5 A graph showing the rate of decrease in weight by heating the hard foam obtained in Example 5 of the present invention.

FIG. 6 A graph showing an infrared absorption spectrum of the p-coumaric acid-caffeic acid copolymer obtained in Example 6 of the present invention.

FIG. 7 A graph showing a nuclear magnetic resonance spectrum of the p-coumaric acid-caffeic acid copolymer obtained in Example 6 of the present invention.

FIG. 8 (i) is a graph showing an infrared absorption spectrum of poly(caffeic acid), (ii) is a graph showing an infrared absorption spectrum of poly(ferulic acid), and (iii) is a graph showing an infrared absorption spectrum of the ferulic acid-caffeic acid copolymer obtained in Example 8 of the present invention.

FIG. 9 A graph showing a nuclear magnetic resonance spectrum of the ferulic acid-caffeic acid copolymer obtained in Example 8 of the present invention within a range of 13 to 0 ppm.

FIG. 10 A graph showing a nuclear magnetic resonance spectrum of the ferulic acid-caffeic acid copolymer obtained in Example 8 of the present invention within a range of 8.2 to 6.4 ppm.

FIG. 11 (i) is a graph showing an infrared absorption spectrum of poly(p-coumaric acid), (ii) is a graph showing an infrared absorption spectrum of poly(ferulic acid), and (iii) is a graph showing an infrared absorption spectrum of the ferulic acid-p-coumaric acid copolymer obtained in Example 10 of the present invention.

FIG. 12 A graph showing a nuclear magnetic resonance spectrum of the ferulic acid-p-coumaric acid copolymer obtained in Example 10 of the present invention.

FIG. 13 A graph showing a nuclear magnetic resonance spectrum of the ferulic acid-p-coumaric acid copolymer obtained in Example 10 of the present invention within a range of 9.0 to 6.0 ppm.

FIG. 14 A graph showing the result of the gas chromatography measurement of poly(ferulic acid) obtained in Example 1 of the present invention in Experiment Example 1.

FIG. 15 A graph showing the result of the EI spectrum measurement in Experiment Example 1 of poly(ferulic acid) obtained in Example 1 of the present invention.

FIG. 16 (a) is an optical photograph of the hard foam obtained in Example 11 of the present invention taken before being buried in the soil in Experiment Example 3, and (b) is an optical photograph of the hard foam taken after being buried in the soil for three months in Experiment Example 3.

### BEST MODE FOR CARRYING OUT THE INVENTION

The hard foam of the present invention is formed from a carboxylic acid ester-based polymer having a ring structure. The hard foam of the present invention is obtained by heating a carboxylic acid ester-based polymer having a ring structure to generate a gaseous organic acid from the carboxylic acid ester-based polymer, and foaming the heated carboxylic acid ester-based polymer with the gaseous organic acid. Therefore, the hard foam of the present invention has some advantageous merits such that the hard foam does not contain carbon dioxide gas which is considered to be a cause of global warming, and that the hard foam is excellent in heat resistance and has high mechanical strength.

Examples of the carboxylic acid ester-based polymer having a ring structure which is used as a raw material of the hard foam of the present invention include a carboxylic acid ester-based polymer containing, as a structural unit, at least one unit selected from the group consisting of a unit represented by the formula (I):

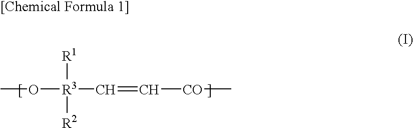

wherein each of R¹ and R² is independently a hydrogen atom, a hydroxyl group, a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms, and R³ is an organic group having a ring structure, and a unit represented by the formula (II):

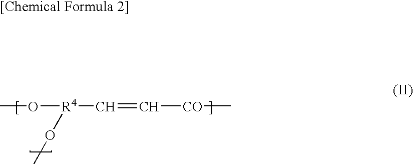

wherein R⁴ is an organic group having a ring structure. In the formula (I), R¹ can be the same as R² or different from R².

From the viewpoint of increasing the softening temperature of the carboxylic acid ester-based polymer, it is preferred that in the formula (I), R¹ is a hydrogen atom, a hydroxyl group, a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms, and R² is a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms.

Moreover, from the viewpoint of increasing the softening temperature of the carboxylic acid ester-based polymer to a temperature of not lower than 150° C., R¹ is a hydrogen atom, a hydroxyl group, a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms, and R² is a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms.

From the viewpoint of increasing the softening temperature of the carboxylic acid ester-based polymer, R¹ is preferably a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms.

From the viewpoint of increasing the softening temperature of the carboxylic acid ester-based polymer, R² is preferably a halogen atom, an alkyl group having 1 to 12 carbon atoms, an alicyclic group having 3 to 12 carbon atoms, or an alkoxy group having 1 to 12 carbon atoms, and more preferably a halogen atom, an alkyl group having 1 to 12 carbon atoms, or an alkoxy group having 1 to 12 carbon atoms.

From the viewpoint of increasing the softening temperature of the carboxylic acid ester-based polymer to a higher temperature, it is more preferred that R¹ is a hydrogen atom or an alkoxy group having 1 to 12 carbon atoms, and R² is an alkoxy group having 1 to 12 carbon atoms, and it is even more preferred that R¹ is an alkoxy group having 1 to 12 carbon atoms, and R² is an alkoxy group having 1 to 12 carbon atoms.

Examples of the halogen atom include a fluorine atom, a chlorine atom, a bromine atom and an iodine atom.

Among the alkyl groups having 1 to 12 carbon atoms, alkyl groups having 1 to 8 carbon atoms are preferred, and alkyl groups having 1 to 4 carbon atoms are more preferred. Suitable alkyl groups having 1 to 4 carbon atoms include a methyl group, an ethyl group, a propyl group and a butyl group. Among these groups, a methyl group is more preferred.

Among alicyclic groups having 3 to 12 carbon atoms, alicyclic groups having 3 to 6 carbon atoms are preferred. The alicyclic groups having 3 to 6 carbon atoms include a cyclopropyl group, a cyclopropylmethyl group and a cyclobutyl group.

Among the alkoxy groups having 1 to 12 carbon atoms, alkoxy groups having 1 to 8 carbon atoms are preferred, and alkoxy groups having 1 to 4 carbon atoms are more preferred. Suitable alkoxy groups having 1 to 4 carbon atoms include a methoxy group, an ethoxy group, a propoxy group, a cyclopropoxy group, a butoxy group, a cyclopropylmethyloxy group and a cyclobutoxy group. Among these groups, a methoxy group is more preferred.

Among the alkanoyl groups having 1 to 12 carbon atoms, alkanoyl groups having 1 to 8 carbon atoms are preferred, and alkanoyl groups having 1 to 4 carbon atoms are more preferred. Suitable alkanoyl groups having 1 to 4 carbon atoms include a formyl group, an ethanoyl group, a propanoyl group, a butanoyl group and a cyclopropylcarbonyl group. Among these groups, an ethanoyl group is more preferred.

Among the alkanoyloxy groups having 1 to 12 carbon atoms, alkanoyloxy groups having 1 to 8 carbon atoms are preferred, and alkanoyloxy groups having 1 to 4 carbon atoms are more preferred. Suitable alkanoyloxy groups having 1 to 4 carbon atoms include a formyloyloxy group, an acetyloyloxy group, a propanoyloxy group, a butanoyloxy group and a cyclopropylcarbonyloxy group. Among these groups, an acetyloyloxy group is more preferred.

Among the alkylthioether groups having 1 to 12 carbon atoms, alkylthioether groups having 1 to 8 carbon atoms are preferred, and alkylthioether groups having 1 to 4 carbon atoms are more preferred. Suitable alkylthioether groups having 1 to 4 carbon atoms include a methylthioether group, an ethylthioether group, a propylthioether group, a cyclopropylthioether group, a cyclopropylmethylthioether group, a butylthioether group and a cyclobutylthioether group. Among these groups, a methylthioether group is more preferred.

Among the alkenyl groups having 2 to 12 carbon atoms, alkenyl groups having 2 to 8 carbon atoms are preferred, and alkenyl groups having 2 to 4 carbon atoms are more preferred. Suitable alkenyl groups having 2 to 4 carbon atoms include an ethenyl group, a propenyl group, a cyclopropenyl group, a butenyl group and a cyclobutenyl group. Among these groups, an ethenyl group is more preferred.

Among the alkynyl groups having 2 to 12 carbon atoms, alkynyl groups having 2 to 8 carbon atoms are preferred, and alkynyl groups having 2 to 4 carbon atoms are more preferred. Suitable alkynyl groups having 2 to 4 carbon atoms include an ethynyl group, a propynyl group, a cyclopropynyl group, a butynyl group and a cyclobutynyl group. Among these groups, an ethynyl group is more preferred.

Among the fluoroalkyl groups having 1 to 12 carbon atoms, fluoroalkyl groups having 1 to 8 carbon atoms are preferred, and fluoroalkyl groups having 1 to 4 carbon atoms are more preferred. Suitable fluoroalkyl groups having 1 to 4 carbon atoms include a fluoromethyl group, a fluoroethyl group, a fluoropropyl group, a fluorocyclopropyl group, a fluorocyclopropylmethyl group, a fluorobutyl group, a fluorocyclobutyl group, a difluoromethyl group, a difluoroethyl group, a difluoropropyl group, a difluorocyclopropyl group, a difluorocyclopropylmethyl group, a difluorobutyl group, a difluorocyclobutyl group, a trifluoromethyl group, a trifluoroethyl group, a trifluoropropyl group, a trifluorocyclopropyl group, a trifluorobutyl group, a trifluorocyclopropylmethyl group, a trifluorocyclobutyl group, a tetrafluoroethyl group and a pentafluoroethyl group. Among these groups, a trifluoromethyl group is more preferred.

As far as an object of the present invention is not hindered, each of R¹ and R² has a concept such that each may have a substituent.

In the unit represented by the formula (I), R³ is an organic group having a ring structure. The unit represented by the formula (I) has an R³ group which is an organic group having a ring structure in order to increase the softening temperature of the carboxylic acid ester-based polymer. From the viewpoint of increasing the softening temperature of the carboxylic acid ester-based polymer, R³ is preferably an aromatic group having 5 to 12 carbon atoms or an alicyclic group having 3 to 30 carbon atoms, more preferably an aromatic group having 5 to 12 carbon atoms, even more preferably an aromatic group having 6 to 12 carbon atoms, and still more preferably a benzene ring. As far as an object of the present invention is not hindered, R³ has a concept such that R³ may have a substituent.

In the unit represented by the formula (I), each of an —O— bond, R¹ and R² may be present at any position relative to the —CH═CH—CO— group bonded to the carboxylic acid ester-based polymer. However, from the viewpoint of increasing the softening temperature by preparing a polymer having a linear chain, it is preferred that R³ is a benzene ring, and that the —O— bond is bonded to the benzene ring at the p-position relative to the —CH═CH—CO— group bonded to the benzene ring. Moreover, from the viewpoint of preparing a biobased carboxylic acid ester-based polymer, it is preferred that R³ is a benzene ring, and that each of R¹ and R² is bonded to the benzene ring at m-position relative to the —CH═CH—CO— group bonded to the benzene ring.

From the viewpoint of increasing the softening temperature of the carboxylic acid ester-based polymer, a suitable unit represented by the formula (I) is a unit represented by the formula (Ia):

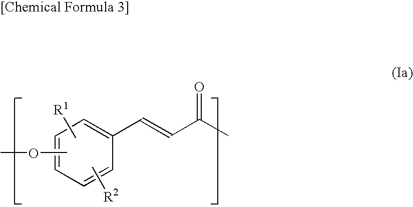

wherein R¹ and R² are the same as defined above.

In the unit represented by the formula (II), R⁴ is an organic group having a ring structure. The unit represented by the formula (II) has an R⁴ group which is an organic group having a ring structure, in order to increase the softening temperature of the carboxylic acid ester-based polymer. From the viewpoint of increasing the softening temperature of the carboxylic acid ester-based polymer, R⁴ is preferably an aromatic group having 5 to 12 carbon atoms or an alicyclic group having 3 to 30 carbon atoms, more preferably an aromatic group having 5 to 12 carbon atoms, even more preferably an aromatic group having 6 to 12 carbon atoms, and still more preferably a benzene ring. As far as an object of the present invention is not hindered, R⁴ has a concept such that R⁴ may have a substituent.

When the carboxylic acid ester-based polymer contains a unit represented by the formula (I) and a unit represented by the formula (II), the carboxylic acid ester-based polymer is a copolymer. Also, when the carboxylic acid ester-based polymer is composed of a unit represented by the formula (I) or a unit represented by the formula (II), the carboxylic acid ester-based polymer is a homopolymer. Therefore, the carboxylic acid ester-based polymer may be any of a homopolymer composed of a unit represented by the formula (I), a homopolymer composed of a unit represented by the formula (II) and a copolymer containing a unit represented by the formula (I) and a unit represented by the formula (II). Among these polymers, the homopolymer composed of a unit represented by the formula (I) is preferred, and a homopolymer composed of a unit represented by the formula (Ia) is more preferred from the viewpoint of increasing the softening temperature of the carboxylic acid ester-based polymer.

When the carboxylic acid ester-based polymer is a copolymer containing a unit represented by the formula (I) and a unit represented by the formula (II), the carboxylic acid ester-based polymer can be a random copolymer or a block copolymer. When raw material monomers are polymerized, a random copolymer is usually formed.

Although the molar ratio of the unit represented by the formula (I) to the unit represented by the formula (II) [unit represented by the formula (I)/unit represented by the formula (II)] is not particularly limited, it is preferred that the above ratio is 100/0 to 1/99 from the viewpoint of increasing the softening temperature of the carboxylic acid ester-based polymer. Incidentally, when the molar ratio of the unit represented by the formula (I) to the unit represented by the formula (II) [unit represented by the formula (I)/unit represented by the formula (II)] is 100/0, the carboxylic acid ester-based polymer is a homopolymer composed of a unit represented by the formula (I).

As far as an object of the present invention is not hindered, the carboxylic acid ester-based polymer may include a unit other than the unit represented by the formula (I) and the unit represented by the formula (II).

It is preferred that the carboxylic acid ester-based polymer has a group which is eliminated from the carboxylic acid ester-based polymer and vaporized to form a gaseous organic acid at its molecular end. It is desired that the carboxylic acid ester-based polymer has at its molecular end a (cyclo)alkanoyloxy group which is eliminated from the carboxylic acid ester-based polymer and vaporized at a temperature up to 150° C. among the groups which are eliminated from the carboxylic acid ester-based polymer and vaporized to form a gaseous organic acid. The (cyclo)alkanoyloxy group referred to herein means an alkanoyloxy group or a cycloalkanoyloxy group.

When the carboxylic acid ester-based polymer has at its molecular end a (cyclo)alkanoyloxy group which is eliminated from the carboxylic acid ester-based polymer and vaporized at a temperature up to 150° C., for example, the carboxylic acid ester-based polymer can be foamed with a gaseous organic acid which is generated by heating the carboxylic acid ester-based polymer to eliminate the (cyclo)alkanoyloxy group from the carboxylic acid ester-based polymer to vaporize, before the main chain of the carboxylic acid ester-based polymer is denatured by heating to a temperature of not lower than 150° C.

Examples of a preferred (cyclo)alkanoyloxy group which is eliminated from the carboxylic acid ester-based polymer and vaporized at a temperature up to 150° C. include alkanoyloxy groups having 2 to 8 carbon atoms represented by the formula (III):

R⁵⁰(CO)— (III)

wherein R⁵ is an alkyl group having 1 to 7 carbon atoms. This alkanoyloxy group may have a substituent as far as an object of the present invention is not hindered.

Since the (cyclo)alkanoyloxy group is eliminated from the carboxylic acid ester-based polymer and vaporized to form a gaseous organic acid when the carboxylic acid ester-based polymer is heated to a temperature of 150° C. or higher under normal pressure, the carboxylic acid ester-based polymer is foamed.

Moreover, when the (cyclo)alkanoyloxy group is the one which is eliminated from the carboxylic acid ester-based polymer at a temperature lower than the softening temperature of the main chain of the carboxylic acid ester-based polymer, and the organic acid resulting from the carboxylic acid ester-based polymer by its elimination has a boiling point higher than the softening temperature of the main chain of the carboxylic acid ester-based polymer, the carboxylic acid ester-based polymer can be heated to melt without foaming. Therefore, the carboxylic acid ester-based polymer can be foamed by heating the carboxylic acid ester-based polymer to a temperature lower than the boiling point of the organic acid, which is generated by eliminating from the carboxylic acid ester-based polymer, to melt the carboxylic acid ester-based polymer, charging a desired mold with the molten carboxylic acid ester-based polymer, and heating the molten carboxylic acid ester-based polymer to a temperature higher than the boiling point of the organic acid.

Accordingly, when the carboxylic acid ester-based polymer has a (cyclo)alkanoyloxy group which is eliminated from the carboxylic acid ester-based polymer at a temperature lower than the softening temperature of the main chain of the carboxylic acid ester-based polymer, and the organic acid resulting from the carboxylic acid ester-based polymer by its elimination has a boiling point higher than the softening temperature of the main chain of the carboxylic acid ester-based polymer, there can be employed a foaming method which comprises heating the carboxylic acid ester-based polymer to melt at a temperature lower than the boiling point of the organic acid, charging a desired mold with the molten carboxylic acid ester-based polymer, and heating the molten carboxylic acid ester-based polymer to a temperature higher than the boiling point of the organic acid, for instance, a so-called foaming method in a mold.

Examples of the (cyclo)alkanoyloxy group which is preferred from the viewpoint of foaming in a mold include (cyclo)alkanoyloxy groups having 6 to 8 carbon atoms represented by the formula (IV):

R⁶O(CO)— (IV)

wherein R⁶ is an alkyl group having 5 to 7 carbon atoms or an alicyclic group having 5 to 7 carbon atoms, and R⁶ is preferably a pentyl group or a hexyl group.

The amount of the group existing at the molecular end of the carboxylic acid ester-based polymer, which is eliminated from the carboxylic acid ester-based polymer and vaporized to form a gaseous organic acid cannot be absolutely determined, because the amount differs depending upon the molecular weight of the carboxylic acid ester-based polymer and the like. Usually, the carboxylic acid ester-based polymer has theoretically at least two groups which are eliminated from the carboxylic acid ester-based polymer and vaporized to form a gaseous organic acid. Also, the carboxylic acid ester-based polymer theoretically has groups which are eliminated from the carboxylic acid ester-based polymer and vaporized to form a gaseous organic acid, in which the number of the groups is 10 greater than the polymerization degree of the polymer.

The number average molecular weight of the carboxylic acid ester-based polymer cannot be absolutely determined because the number average molecular weight differs depending upon, for example, kinds of a recurring unit constituting the polymer. The number average molecular weight of the polymer is usually preferably 3000 to 1000000, more preferably 3000 to 100000, and even more preferably 5000 to 90000 from the viewpoint of readily foaming the carboxylic acid ester-based polymer and improvement in moldability.

The carboxylic acid ester-based polymer can be easily prepared by polymerizing raw material monomers corresponding to the units constituting the polymer.

Representative examples of the raw material monomer include amino acids such as thyrosine, dopa, β-tyrosine and m-thyrosine; cinnamic acids such as o-coumaric acid, m-coumaric acid, p-coumaric acid, ferulic acid, isoferulic acid, sinapic acid, caffeic acid, chlorogenic acid, melilotic acid, phloretic acid, umbellic acid, hydroferulic acid, hydroisoferulic acid and hydrocaffeic acid; polyphenols such as prephenic acid, gallic acid, arogenic acid, 3-amino-4-hydroxybenzoic acid, gentisic acid, homogentisic acid, m-salicylic acid, p-salicylic acid, pyrocatechuic acid, protocatechuic acid, vanillylmandelic acid, orsellinic acid, creosote acid, vanillic acid, homovanillic acid, isovanillic acid, homoisovanillic acid, o-salicylic acid, o-homosalicylic acid, m-homosalicylic acid, p-homosalicylic acid, syringic acid, γ-resorcinol acid, α-resorcinol acid and β-resorcinol acid; natural acids such as mandelic acid and atrolactinic acid; other aromatic acids such as benzilic acid, hydroxynaphthoic acid and tropic acid; saccharides such as glucuronic acid, mannuronic acid, galacturonic acid, guluronic acid, iduronic acid, muramic acid and N-acetylmuramic acid; and other fatty acids such as chorismic acid, dehydroshikimic acid, dehydroquinic acid, quinic acid and shikimic acid. The present invention, however, is not limited only to these exemplified ones. These raw material monomers can be used alone or in admixture of at least two kinds.

Preferred examples of the raw material monomer include thyrosine, dopa, β-thyrosine, m-thyrosine, o-coumaric acid, m-coumaric acid, ferulic acid, isoferulic acid, sinapic acid and chlorogenic acid, and these raw material monomers can be used alone or in admixture of at least two kinds. Among these raw material monomers, ferulic acid, sinapic acid, o-coumaric acid and m-coumaric acid are preferred, ferulic acid, sinapic acid and o-coumaric acid are more preferred, ferulic acid and sinapic acid are even more preferred, and ferulic acid is particularly preferred from the viewpoint of improvement in solubility and heat resistance of the carboxylic acid ester-based polymer.

Incidentally, ferulic acid can be obtained from a rice bran extract, and para-coumaric acid can be extracted from potato. Therefore, the raw material monomers derived from plants, such as polyphenols are advantageously used from the viewpoint of environmental aspects.

When a monomer having two functional groups which participate in polymerization, for example, a hydroxyl group and a carboxyl group (an AB type monomer) such as ferulic acid is polymerized as a raw material monomer, or when a reaction which induces branching due to a steric hindrance fails to occur in polymerizing a monomer having three functional groups which participate in polymerization, such as two hydroxyl groups and a carboxyl group (an AB2 type monomer) such as caffeic acid under polymerization reaction conditions including a temperature of 200° C. or lower and a period of about 10 to about 30 minutes, a polymer composed of a unit represented by the formula (I) is obtained.

When a reaction which induces branching is carried out by polymerizing, for example, a monomer having three functional groups which participate in polymerization, such as two hydroxyl groups and a carboxyl group (an AB2 type monomer) such as caffeic acid is polymerized as a raw material monomer under polymerization reaction conditions including a temperature of 200° C. or higher and a period longer than 30 minutes, for example, at 200° C. for 6 hours, a polymer composed of a unit represented by the formula (I) and a unit represented by the formula (II), or a polymer composed of a unit represented by the formula (II) is obtained. However, it has been confirmed from the researches of the present inventors that a polymer having a unit represented by the formula (I) and a unit represented by the formula (II) are usually readily produced.

Furthermore, when a monomer having two functional groups which participate in polymerization, such as a hydroxyl group and a carboxyl group (an AB type monomer) such as ferulic acid, and a monomer having three functional groups which participate in polymerization, such as two hydroxyl group and a carboxyl group (an AB2 type monomer) such as caffeic acid are copolymerized as raw material monomers, a polymer composed of a unit represented by the formula (I) and a unit represented by the formula (II) is obtained.

The raw material monomers can be previously alkanoylated as occasion demands. The alkanoylation can be carried out by a conventional method, and the present invention is not limited to the method for alkanoylation. The method for alkanoylation includes, for example, a method for alkanoylating a raw material monomer with an organic acid. Also, the carboxylic acid ester-based polymer can be alkanoylated with an organic acid after the carboxylic acid ester-based polymer is prepared in the present invention.

Preferred organic acids include a carboxylic acid which can form an ester with a hydroxyl group of a raw material monomer, which has a boiling point of 250° C. or lower, and which has no functional group inhibiting polymerization, such as an amino group or a hydroxyl group. The reason why the boiling point of the organic acid is preferably 250° C. or lower is that the decomposition of an alkanoylated portion of the carboxylic acid ester-based polymer is inhibited, for example, when the carboxylic acid ester-based polymer is heated for foaming.

Examples of the carboxylic acid include aliphatic carboxylic acids having a boiling point of 250° C. or lower, such as formic acid, acetic acid, propionic acid, butanoic acid, pentanoic acid, hexanoic acid, heptanoic acid, octanoic acid, and their constitutional isomers; cyclic carboxylic acids having a boiling point of 250° C. or lower, such as cyclopropanecarboxylic acid, cyclobutanecarboxylic acid, cyclopentanecarboxylic acid, cyclohexanecarboxylic acid, cycloheptanecarboxylic acid, cyclooctanecarboxylic acid and their constitutional isomers; aliphatic carboxylic acids having a substituent, the boiling point of which is 250° C. or lower, such as fluoroacetic acid, difluoroacetic acid, trifluoroacetic acid, chloroacetic acid, dichloroacetic acid, trichloroacetic acid, bromoacetic acid, iodoacetic acid and cyanoacetic acid; and unsaturated aliphatic carboxylic acids having a boiling point of 250° C. or lower, such as benzoic acid, pyruvic acid, acrylic acid, methacrylic acid, butenoic acid, pentenoic acid, hexenoic acid, heptenoic acid and octenoic acid. The present invention, however, is not limited to those exemplified ones.

Among the carboxylic acids, formic acid, acetic acid, propionic acid, butanoic acid, pentanoic acid, hexanoic acid, heptanoic acid and octanoic acid are preferred, and acetic acid is more preferred from the viewpoint of high efficiency of foaming due to its low boiling point and low toxicity.

Moreover, when the carboxylic acid has a boiling point higher than the softening temperature of a carboxylic acid ester-based polymer, the carboxylic acid ester-based polymer which is alkanoylated with the carboxylic acid can be heated to melt at a temperature not lower than the softening point of the carboxylic acid ester-based polymer and lower than the boiling point of the carboxylic acid, and the molten carboxylic acid ester-based polymer can be filled into a desired mold without the generation of foaming. After filling the carboxylic acid ester-based polymer into the mold, the carboxylic acid ester-based polymer can be foamed by heating the polymer to a temperature equal to or higher than the boiling point of the carboxylic acid. The carboxylic acid suitable for foaming the carboxylic acid ester-based polymer includes a carboxylic acid having an alkyl group of 5 to 7 carbon atoms or an alicyclic group of 5 to 7 carbon atoms. Among them, hexanoic acid is preferred.

Accordingly, when the carboxylic acid ester-based polymer alkanoylated with the carboxylic acid is used in the present invention, the carboxylic acid ester-based polymer can be heated to melt without foaming. Hence, the carboxylic acid ester-based polymer can be foamed by filling the carboxylic acid ester-based polymer being heated to melt at a temperature lower than the boiling point of the carboxylic acid into a desired mold, and thereafter further heating the molten carboxylic acid ester-based polymer to a temperature equal to or higher than the boiling point of the carboxylic acid. Therefore, when this carboxylic acid ester-based polymer is heated to melt, and the molten carboxylic acid ester-based polymer is filled into a mold, there is an advantageous merit in that a foamed article having no voids can be produced since the carboxylic acid ester-based polymer can be molded without the generation of vacant spaces in a mold.

The carboxylic acid ester-based polymer can be suitably used for a method comprising heating the polymer to melt, subsequently filling the molten polymer into a desired mold, and thereafter foaming the polymer, for example, by a method for foaming in a mold.

Incidentally, the other monomer such as styrene can be included in the raw material monomer as far as an object of the present invention is not hindered.

Examples of a method for polymerizing the raw material monomers include bulk polymerization, solution polymerization, suspension polymerization and emulsion polymerization. Among them, bulk polymerization and solution polymerization are preferred, and bulk polymerization is more preferred. For example, when the carboxylic acid ester-based polymer is prepared by bulk polymerization, the carboxylic acid ester-based polymer can be easily prepared by acetylating the raw material monomers as occasion demands, and thereafter polymerizing the monomers in the presence of an esterification catalyst.

Examples of the esterification catalyst include metal salts of formic acid, such as lithium formate, sodium formate, potassium formate, rubidium formate, cesium formate, magnesium formate, calcium formate, strontium formate and barium formate; metal salts of acetic acid, such as lithium acetate, sodium acetate, potassium acetate, rubidium acetate, cesium acetate, magnesium acetate, calcium acetate, strontium acetate and barium acetate; metal salts of oxalic acid, such as lithium oxalate, sodium oxalate, potassium oxalate, rubidium oxalate, cesium oxalate, magnesium oxalate, calcium oxalate, strontium oxalate and barium oxalate; metal salts of cinnamic acid, such as lithium cinnamate, sodium cinnamate, potassium cinnamate, rubidium cinnamate, cesium cinnamate, magnesium cinnamate, calcium cinnamate, strontium cinnamate and barium cinnamate; metal salts of carbonic acid, such as lithium carbonate, sodium carbonate, potassium carbonate, rubidium carbonate, cesium carbonate, magnesium carbonate, calcium carbonate, strontium carbonate and barium carbonate; metal salts of phosphoric acid, such as trilithium phosphate, trisodium phosphate, tripotassium phosphate, trirubidium phosphate, tricesium phosphate, dilithium hydrogen phosphate, disodium hydrogen phosphate, dipotassium hydrogen phosphate, dirubidium hydrogen phosphate, dicesium hydrogen phosphate, magnesium hydrogen phosphate, calcium hydrogen phosphate, strontium hydrogen phosphate, barium hydrogen phosphate, lithium dihydrogen phosphate, sodium dihydrogen phosphate, potassium dihydrogen phosphate, rubidium dihydrogen phosphate and cesium dihydrogen phosphate; metal salts of diphosphoric acid, such as trimagnesium diphosphate, tricalcium diphosphate, tristrontium diphosphate, tribarium diphosphate, magnesium tetrahydrogen diphosphate, calcium tetrahydrogen diphosphate, strontium tetrahydrogen diphosphate and barium tetrahydrogen diphosphate; metal salts of polyphosphoric acid, such as lithium polyphosphate, sodium polyphosphate, potassium polyphosphate, rubidium polyphosphate, cesium polyphosphate, magnesium polyphosphate, calcium polyphosphate, strontium polyphosphate and barium polyphosphate; metal salts of metaphosphoric acid, such as lithium metaphosphate, sodium metaphosphate, potassium metaphosphate, rubidium metaphosphate, cesium metaphosphate, magnesium metaphosphate, calcium metaphosphate, strontium metaphosphate and barium metaphosphate; metal oxides, such as lithium oxide, sodium oxide, potassium oxide, rubidium oxide, cesium oxide, magnesium oxide, calcium oxide, strontium oxide and barium oxide; alkali metals, such as metallic lithium, metallic sodium, metallic potassium, metallic rubidium and metallic cesium; and alkaline earth metals, such as metallic magnesium, metallic calcium, metallic strontium and metallic barium. The present invention, however, is not limited only to those exemplified ones. These esterification catalysts can be used alone or in admixture of at least two kinds.

Among the above-mentioned esterification catalysts, sodium acetate, potassium acetate, magnesium acetate, calcium acetate, sodium phosphate, potassium phosphate, trimagnesium diphosphate, tricalcium diphosphate, disodium hydrogen phosphate, dipotassium hydrogen phosphate, sodium polyphosphate, potassium polyphosphate, magnesium polyphosphate and calcium polyphosphate are preferred, and sodium phosphate is more preferred.

The amount of the esterification catalyst cannot be absolutely determined because the amount differs depending upon the kind of the raw material monomer used in the polymerization, and the like. The amount of the esterification catalyst is usually preferably 1 to 50 parts by weight, more preferably 1 to 30 parts by weight, and even more preferably 1 to 10 parts by weight per 100 parts by weight of the raw material monomers.

When the carboxylic acid ester-based polymer is prepared by solution polymerization, an organic solvent which does not participate in the reaction can be used. Examples of the organic solvent which does not participate in the reaction include toluene, hexane, dioxane, tetrahydrofuran, diethyl ether, acetone and methyl ethyl ketone. Among them, hexane and toluene are preferred because water generated during the esterification reaction can be easily removed.

The polymerization temperature is preferably 130° C. or higher, and more preferably 150° C. or higher from the viewpoint of improvement in reaction efficiency, and preferably 250° C. or lower, and more preferably 225° C. or lower from the viewpoint of prevention of foaming during the reaction.

Although the period of the polymerization reaction cannot be absolutely determined because the period differs depending on the reaction conditions and the like, the period is usually about 1 to about 72 hours, preferably about 1 to about 30 hours, more preferably about 1 to about 15 hours, and even more preferably about 1 to about 7 hours.

Although the atmosphere during the polymerization reaction is not particularly limited, the atmosphere is preferably an atmosphere of inert gas such as nitrogen gas or argon gas in order to prevent oxygen contained in the air from participating in the reaction.

In the initial stage of the polymerization reaction, it is preferable that the esterification reaction is advanced while stirring the raw material monomer, and thereafter by-products such as acetic acid are removed by reducing the pressure in the system with a rotary pump, a rotary evaporator or the like. Although the reduced pressure is not particularly limited, the reduced pressure is usually about 1 to about 50 kPa. When the reaction is advanced so that the carboxylic acid ester-based polymer formed is solidified, the reaction can be finished at that time.

When the polymerization reaction is carried out, a polymerization inhibitor such as hydroquinone or p-methoxyphenol, a filler such as silica, talc, kaolin, mica, titanium oxide, kenaf, ramie, montmorillonite, bentonite, carbon fiber, glass fiber or wood flour, a colorant such as dye or pigment such as carbon black can be add to the raw material monomers.

A carboxylic acid ester-based polymer is thus obtained by polymerizing the raw material monomers as mentioned above.

The carboxylic acid ester-based polymer can be used, for example, in the form of powder. Although the particle diameter of the powder of the carboxylic acid ester-based polymer is not particularly limited, it is preferred that the particle diameter is usually about 0.1 to about 100 μm.

Although the carboxylic acid ester-based polymer itself has a foaming ability, the carboxylic acid ester-based polymer may contain a foaming agent as far as an object of the present invention is not hindered.

Moreover, the carboxylic acid ester-based polymer can be used by mixing with the other resin. When the carboxylic acid ester-based polymer is used by mixing with the other resin as mentioned above, the other resin can be foamed.

Examples of the other resin include polyesters such as polyethylene terephthalate, polyolefins such as polyethylene and polypropylene, vinyl chloride resins, polystyrene, ABS resin, acrylic resin, polysulfone, polyether and phenoxy resin. The present invention, however, is not limited to those exemplified ones.

When the carboxylic acid ester-based polymer is used by mixing with the other resin, the carboxylic acid ester-based polymer and a thermoplastic resin such as polyethylene, polypropylene or vinyl chloride resin as the other resin can be uniformly dispersed by heating these resins and kneading the resulting molten resins. Alternatively, the carboxylic acid ester-based polymer and the other resin can be uniformly dispersed by dissolving these resins in an organic solvent which can dissolve these resins.

Since the carboxylic acid ester-based polymer itself has a property for foaming at the time being heated, when the carboxylic acid ester-based polymer is heated to a desired temperature, a group is eliminated from the polymer to vaporize, and a gaseous organic acid is generated. At that time, no carbon dioxide gas is generated. Accordingly, the carboxylic acid ester-based polymer has an advantageous merit such that the carboxylic acid ester-based polymer is friendly to the global environment, because the carboxylic acid ester-based polymer is foamed with an gaseous organic acid generated therefrom, and does not generate carbon dioxide gas, which has conventionally been generated when a foam is produced.

When a hard foam is produced from the carboxylic acid ester-based polymer, the hard foam can be produced by heating the carboxylic acid ester-based polymer at 150° to 300° C. to foam.

More specifically, a hard foam having a desired shape can be produced by heating the carboxylic acid ester-based polymer in a mold being heated to 150° to 300° C. under pressure as occasion demands for about 10 minutes to about 6 hours.

Incidentally, a hard foam can be produced by heating the carboxylic acid ester-based polymer at a temperature of about 180° to about 280° C. under the pressure of about 5 to about 100 MPa for about 5 to about 30 minutes, and thereafter releasing the pressure. Furthermore, a hard foam also can be produced by heating the carboxylic acid ester-based polymer at a temperature of about 230° to about 280° C. under a reduced pressure of 0.1 MPa or lower for about 3 to about 10 minutes, or by maintaining the carboxylic acid ester-based polymer at a temperature of about 150° to about 210° C. under the reduced pressure of 0.1 MPa or lower for about 2.5 to about 3.5 hours.

Since a hard foam can be easily produced only by heating the carboxylic acid ester-based polymer at a desired temperature as mentioned above, the carboxylic acid ester-based polymer has an advantageous merit such that a hard foam can be produced in high production efficiency.

The expansion ratio of the hard foam is preferably 1.1 times or more, more preferably 1.2 times or more, and even more preferably 1.5 times or more from the viewpoint of reducing of its weight and reducing of dielectric constant, and improvement in its vibration insulating property. The expansion ratio of the hard foam is preferably 50 times or less, more preferably 30 times or less, and even more preferably 10 times or less from the viewpoint of improvement in mechanical strength.

The expansion ratio of a hard foam is determined by dividing the volume of the hard foam by the volume of the carboxylic acid ester-based polymer. The expansion ratio can be easily controlled by adjusting the conditions such as heating temperature and heating time in foaming the carboxylic acid ester-based polymer, pressure during heating, reduced pressure during heating, kind and amount of the filler used, molecular weight of the carboxylic acid ester-based polymer, and conditions for pre-crosslinking with light irradiation.

The average cell diameter of the hard foam is preferably 10 nm or more, and more preferably 0.1 μm or more from the viewpoint of providing pores with a size as large as the long period structure of general polymers, and preferably 1 mm or less, and more preferably 100 μm or less from the viewpoint of improvement in mechanical strength. The average cell diameter means an average of the diameters of the cells of a hard foam photographed by a scanning electron microscope such as a field emission scanning electron microscope. The average cell diameter can be easily controlled by adjusting the conditions such as heating temperature and heating time in foaming the carboxylic acid ester-based polymer, pressure during heating, reduced pressure during heating, kind and amount of the filler used, molecular weight of the carboxylic acid ester-based polymer, and conditions of pre-crosslinking with light irradiation.

The above-mentioned hard foam is excellent in heat resistance and has high mechanical strength. Therefore, the hard foam is expected to be applied to, for example, automobile component materials, materials for airplanes, materials for the space field, materials for various industries, materials for medical assistance, and the like.

### EXAMPLES

Next, the present invention is described in more detail based on examples, but the present invention is not limited only to the examples.

### Production Example 1

### Preparation of Acetylated Ferulic Acid

A 500-mL short-neck flask was charged with 25 g of ferulic acid, 200 mL of toluene, 50 mL of acetic anhydride and 10 mL of pyridine, and a reaction was carried out at 110° C. for 2 hours under stirring. After the completion of the reaction, the resulting reaction mixture was cooled to room temperature, and added to hot water of 90° to 100° C., followed by stirring so that a uniform composition could be formed. After the stirring, the solution of the reaction mixture was allowed to stand. As a result, the solution separated into two layers, an oil layer and an aqueous layer, and white crystals gradually deposited in the aqueous layer. The resulting white crystals were collected by filtration and the collected material was washed with 1000 mL of hot water and dried at 60° C. for 24 hours with a dryer.

The infrared absorption spectrum (IR) and the nuclear magnetic resonance (¹H-NMR) of the resulting white crystals were examined. As a result, it was confirmed that the crystals were made of acetylated ferulic acid.

### Example 1

### Preparation of Poly(Ferulic Acid)

Into a 500-mL separable flask were added 10 g of acetylated ferulic acid obtained in Production Example 1 and 0.1 g of sodium phosphate as a catalyst, which were then heated from room temperature to 190° C. under a nitrogen gas flow and polymerized while being stirred with a mechanical stirrer. After heating and stirring the product for 2 hours from the commencement of the polymerization, the pressure in the flask was reduced to 1 kPa or lower by using a rotary pump, and the polymerization was carried out at 190° C. for additional 0.5 to 4 hours. The polymerization reaction was stopped when the resulting product solidified. Thereafter, a massive solid matter having a diameter of about 20 to about 30 mm was obtained by cooling the resulting product.

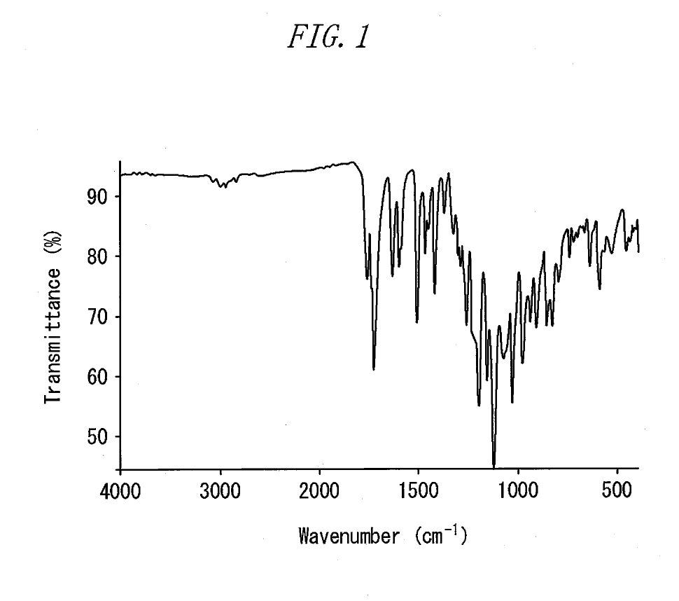

The infrared absorption spectrum (IR) of the obtained solid matter was examined by using an infrared absorption spectrometer (commercial name: Spectrum One, manufactured by PerkinElmer Co., Ltd.). The results are shown in FIG. 1 and below.

IR (ATR) νₘₐₓ (cm⁻¹): 1255, 1219 (ether), 1598 (benzene ring), 1633 (vinylene), 1722 (ester)

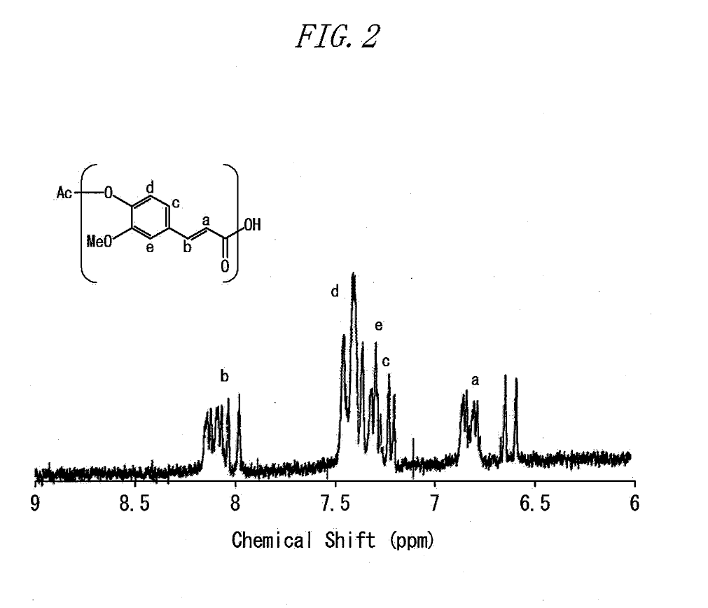

Moreover, the nuclear magnetic resonance (¹H-NMR) of the obtained solid matter was examined by using a nuclear magnetic resonance spectrometer (commercial name: Gemini-2000, manufactured by Varian, Inc.). The results are shown in FIG. 2 (unit of the horizontal axis: ppm) and below. In FIG. 2, Ac represents an acetyl group and MeO represents a methoxy group. Each of a, b, c, d, and e in the chemical formula shown in FIG. 2 represents the attribution of each peak shown in FIG. 2, respectively.

¹H-NMR (DMSO-d6), δ (mass ppm): 3.9-4.0 (methoxy group), 6.8-6.9 (a in FIG. 2), 7.2-7.3 (c in FIG. 2), 7.3-7.4 (e in FIG. 2), 7.4-7.5 (d in FIG. 2), 8.0-8.2 (b in FIG. 2)

From the measurement results of the infrared absorption spectrum (IR), it was confirmed that the solid matter obtained in Example 1 was poly(ferulic acid) represented by the formula (Ia), wherein R¹ exists at the m-position relative to the —CH═CH—CO— group, an —O— group exists at the p-position relative to the —CH═CH—CO— group, R¹ is a methoxy group, and R² is a hydrogen atom. Moreover, from the measurement results of ¹H-NMR, it was confirmed that the number average molecular weight of the obtained poly(ferulic acid) was 10000.

### Example 2

### Production of Hard Foam of Poly(Ferulic Acid)

The massive poly(ferulic acid) obtained in Example 1 was ground with a mill so that the resultant particles might have a diameter of about 0.1 to about 100 μm, and the resulting powder was filled into a mold having an internal shape of 50 mm in length, 6 mm in width, and 7 mm in depth, and compression molding was carried out for 20 minutes at a temperature of 200° C. under a pressure of 5 MPa. Thereafter, the pressure was released and the powder was heated at a temperature of 250° C. for 15 minutes without taking out of the powder from the mold, so that poly(ferulic acid) was foamed, to give a hard foam.

The expansion ratio and the average cell diameter of the resulting hard foam were examined. As a result, the expansion ratio was 7 times and the average cell diameter was 12 μm. The gas generated during the production of the hard foam was examined. As a result, it was confirmed that the gas generated was acetic acid.

The fact that the gas generated was acetic acid was confirmed by cutting a part of the obtained hard foam to give a piece, thermally decomposing the piece with hot water, and analyzing the gas generated from the piece with a thermal decomposition gas chromatograph-mass spectrometer [commercial name: Clarus 500 GC/MS, manufactured by PerkinElmer Japan Co., Ltd.]. In each example, the gas generated was analyzed in the same manner as the above.

In each example, the expansion ratio was determined by dividing the volume of the hard foam by the volume of the carboxylic acid ester-based polymer before foaming. In each example, the average cell diameter was determined by measuring the cell diameters of 50 cells of the hard foam photographed by a field emission scanning electron microscope, and calculating the average of the cell diameters.

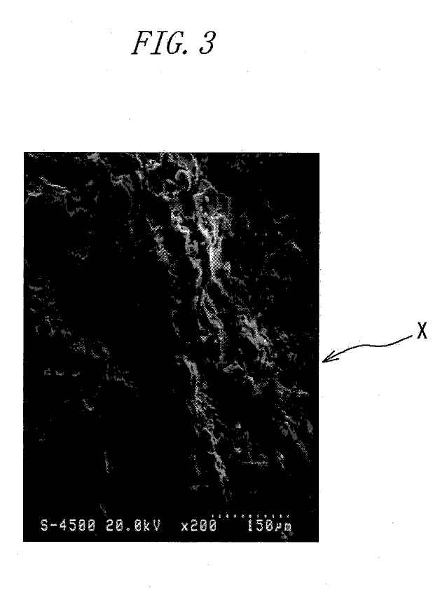

The hard foam was cut with a knife, and a scanning electron microscope (SEM) photograph of the cross section was taken. The result is shown in FIG. 3. The photographing magnification of the photograph is 200 times as indicated in FIG. 3. The SEM photograph shown in FIG. 3 shows that the hard foam has many cells having pore diameters ranging from the order of nanometer to the order of millimeter as indicated by sign X.

Next, as the physical properties of the obtained hard foam, mechanical strength (compressive strength) and heat resistance were examined in accordance with the following measuring methods. As a result, it was confirmed that the compressive strength of the obtained hard foam was 23 MPa, and that the hard foam is excellent in heat resistance since no deformation or the like was observed in the hard foam even when the hard foam was exposed to a atmosphere having a high temperature of 300° C. for 12 hours.

### [Method for Measuring Compressive Strength]

A test piece (3 mm in length, 4 mm in width, and 3 mm in thickness) was prepared by slicing or cutting a hard foam. The test piece was sandwiched between two stainless steel jigs each having a smooth place at the surface being contacted with the test piece, and a compression test was carried out by applying pressure between the two jigs at room temperature. The compressive strength was determined by dividing the maximum load when the test piece was broken by the cross-sectional area of the test piece (3×4=12 mm²).

### [Method for Measuring Heat Resistance]

A hard foam was placed in an oven. The temperature of the internal atmosphere in the oven was controlled to 300° C., and the hard foam was heated for 12 hours. Thereafter, the hard foam was taken out from the oven, and it was confirmed whether or not the heated hard foam had any failure such as deformation.

Next, a brass line having a diameter of 1 mm was soldered to the surface of the obtained hard foam with lead-free solder (melting point: about 200° C.). As a result, the brass line was soldered to the hard foam without causing thermal deformation or the like, nevertheless the hard foam was made of a resin.

From this fact, it can be seen that soldering can be easily applied to the hard foam obtained in Example 2, since the hard foam is not only excellent in heat resistance, but also has fine cells.

### Example 3

### Production of Hard Foam of Poly(Ferulic Acid)

The massive poly(ferulic acid) obtained in Example 1 was heated at a temperature of 250° C. for 20 minutes under the condition such that a pressure of 5 MPa was applied to the poly(ferulic acid) with a hot pressing machine, and thereafter, the pressure was released from the poly(ferulic acid). As a result, the poly(ferulic acid) was foamed, to give a hard foam.

The obtained hard foam had an expansion ratio of 7 times and an average cell diameter of 12 μm. The hard foam was cut with a knife, and a scanning electron microscope (SEM) photograph of the cross section was taken. As a result, it was confirmed that many cells having pore diameters ranging from the order of nanometer to the order of millimeter are present in the obtained hard foam, as well as the hard foam obtained in Example 2. The gas generated during the production of the hard foam was examined. As a result, it was confirmed that the gas generated was acetic acid.

Next, as the physical properties of the obtained hard foam, mechanical strength (compressive strength) and heat resistance were examined in the same manner as in Example 2. As a result, it was confirmed that the compressive strength of the hard foam was 25 MPa, and that the hard foam was excellent in heat resistance since no deformation or the like was observed in the hard foam even when the hard foam was exposed to the atmosphere having a high temperature of 300° C. for 12 hours.

Next, a brass line having a diameter of 1 mm was soldered to the surface of the obtained hard foam with lead-free solder (melting point: about 200° C.). As a result, the brass line was soldered to the hard foam without causing thermal deformation or the like, nevertheless the hard foam was made of a resin.

From this fact, it can be seen that soldering can be easily applied to the hard foam obtained in Example 3, since the hard foam is not only excellent in heat resistance, but also has fine cells.

### Example 4

### Preparation of Poly(M-Coumaric Acid)

Poly(m-coumaric acid) was prepared in the same manner as in Example 1 except that 10 g of acetylated m-coumaric acid was used instead of 10 g of acetylated ferulic acid used in Example 1.

The infrared absorption spectrum (IR) and the nuclear magnetic resonance (¹H-NMR) of the obtained poly(m-coumaric acid) were examined in the same manner as in Example 1. As a result, it was confirmed that the number average molecular weight of the obtained poly(m-coumaric acid) was 15000, that an —O— group existed at the m-position relative to the —CH═CH—CO— group in the formula (Ia), and that each of R¹ and R² was hydrogen atom, respectively.

Next, a brass line having a diameter of 1 mm was soldered to the surface of the obtained hard foam with lead-free solder (melting point: about 200° C.). As a result, the brass line was soldered to the hard foam without causing thermal deformation or the like, nevertheless the hard foam was made of a resin.

From this fact, it can be seen that soldering can be easily applied to the hard foam obtained in Example 4, since the hard foam is not only excellent in heat resistance, but also has fine cells.

### Example 5

### Production of Hard Foam of Poly(M-Coumaric Acid)

A hard foam was produced from the poly(m-coumaric acid) obtained in Example 4 in the same manner as in Example 2. The expansion ratio of the obtained hard foam was examined. As a result, the expansion ratio was 7 times. Also, the average cell diameter of the hard foam was 12 μm. The hard foam was cut with a knife, and a scanning electron microscope (SEM) photograph of the cross section was taken. As a result, it was confirmed that many cells having pore diameters ranging from the order of nanometer to the order of millimeter are present in the obtained hard foam, as well as the hard foam obtained in Example 2.

As the physical properties of the obtained hard foam, mechanical strength (compressive strength) and heat resistance were examined in the same manner as in Example 2. As a result, it was confirmed that the compressive strength of the hard foam was 30 MPa, and that the hard foam was excellent in heat resistance, since no deformation or the like was observed in the hard foam even when the hard foam was exposed to the atmosphere having a high temperature of 300° C. for 12 hours. Also, the gas generated from the hard foam during the production of the hard foam was examined. As a result, it was confirmed that the gas generated was acetic acid.

Next, a brass line having a diameter of 1 mm was soldered to the surface of the obtained hard foam with lead-free solder (melting point: about 200° C.). As a result, the brass line was soldered to the hard foam without causing thermal deformation or the like, nevertheless the hard foam was made of a resin.

From this fact, it can be seen that soldering can be easily applied to the hard foam obtained in Example 5, since the hard foam is not only excellent in heat resistance, but also has fine cells.

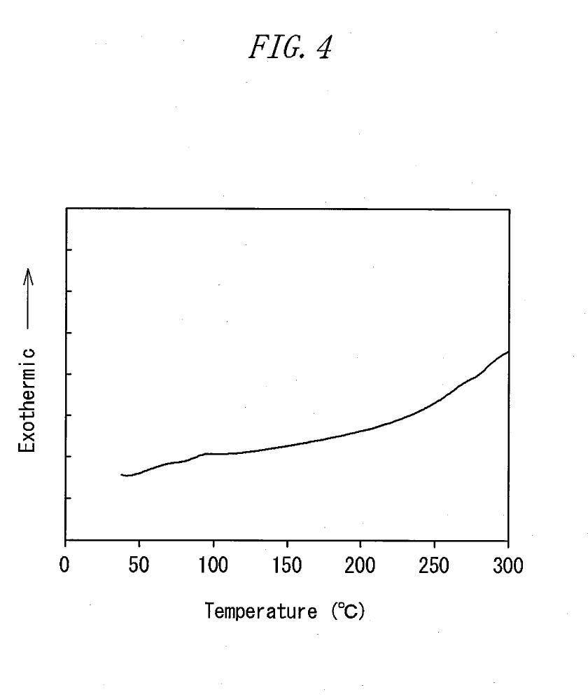

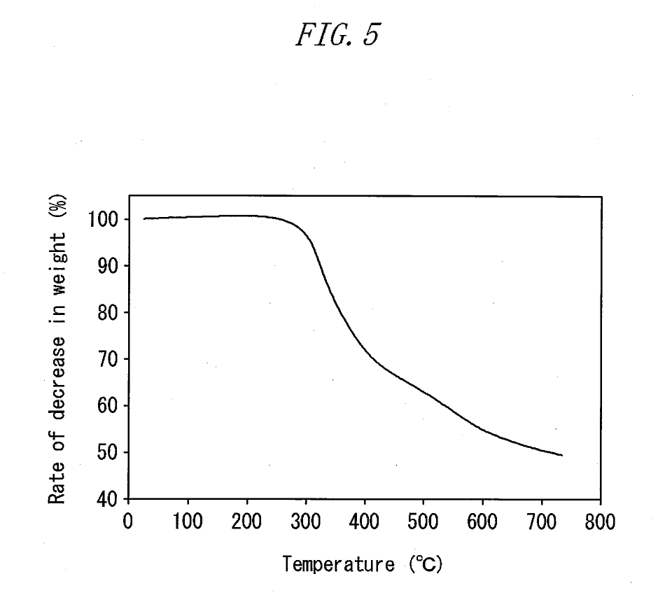

Moreover, the differentially scanned calorimetric variation and the rate of decrease in weight by heating of the obtained hard foam were determined with a thermal analyzer [model No.: SSC5200, manufactured by Seiko Instruments, Inc.]. The measurement results of the differentially scanned calorimetric variation and the rate of decrease in weight are shown in FIG. 4 and FIG. 5, respectively.

From the results shown in FIG. 4 and FIG. 5, it can be seen that the hard foam obtained in Example 5 is excellent in heat resistance, since almost no thermal plasticity and almost no decrease in weight were observed in the hard foam up to about 300° C. Also, from the measurement result of the rate of decrease in weight shown in FIG. 5, it can be seen that the decomposition of the hard foam begins from the temperature exceeding about 310° C. From this fact, it can be seen that the hard foam obtained in Example 5 is excellent in heat resistance even at high temperatures of about 300° C.

### Example 6

### Preparation of a P-Coumaric Acid-Caffeic Acid Copolymer

Into a 500-mL separable flask were added 4 g of p-coumaric acid and 6 g of caffeic acid as monomers, 0.1 g of sodium phosphate as a catalyst and 20 g of hexanoic anhydride as a hexanoylating agent, which were then heated from room temperature to 190° C. under a nitrogen gas flow and were polymerized while being stirred with a mechanical stirrer. After the heating and stirring of the product were carried out for 2 hours from the commencement of the polymerization, the pressure in the flask was reduced to 1 kPa or lower with a rotary pump, and the polymerization was carried out at 190° C. for additional 0.5 to 4 hours. The polymerization reaction was stopped when the resulting product solidified. Thereafter, a massive solid matter was obtained by cooling the resulting product.

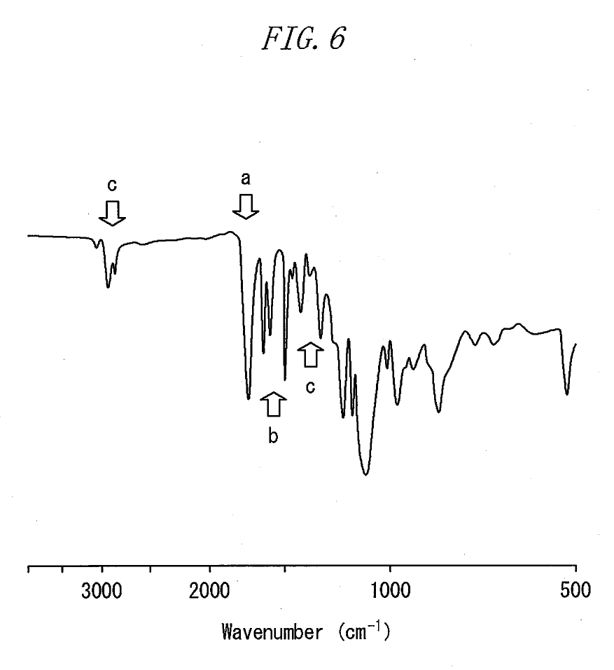

The infrared absorption spectrum (IR) of the obtained solid matter was examined by using an infrared absorption spectrometer (commercial name: Spectrum One, manufactured by PerkinElmer Co., Ltd.). The result is shown in FIG. 6.

From the result shown in FIG. 6, a peak indicating the presence of an alkyl group represented by sign c is confirmed at a wave number of around 2900 cm⁻¹ in the obtained polymer, in addition to a peak characteristic in ester group represented by sign a and a peak characteristic in benzene ring represented by sign b.

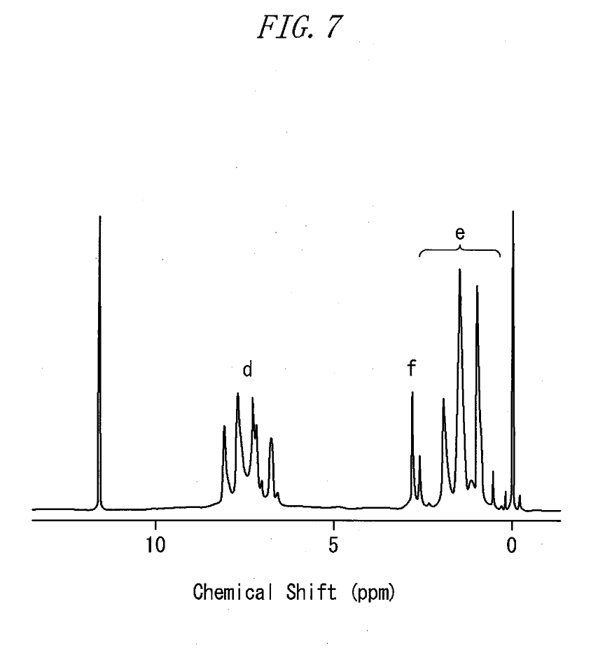

Moreover, the nuclear magnetic resonance (¹H-NMR) of the obtained solid matter was examined by using a nuclear magnetic resonance spectrometer (commercial name: Gemini-2000, manufactured by Varian, Inc.). The results are shown in FIG. 7 (unit of the horizontal axis: ppm).

From the result shown in FIG. 7, a signal represented by sign e which is based on a hexanoyl group is recognized, in addition to a signal represented by sign d which is based on a benzene ring. Sign f represents a signal based on a signal of a hydrogen.

It can be seen from the integrated area ratio of each peak that the obtained copolymer was composed of 36 mol % of p-coumaric acid and 64 mol % of caffeic acid, and that the rate of hexanoylation was 43 mol % to the whole monomers.

The rate of hexanoylation is considered to ideally almost corresponding to the composition of caffeic acid. In contrast, the rate of hexanoylation was 43 mol % to the whole monomers as to the copolymer obtained in this example. This is considered to be based on the fact that a hexanoyl group is bulky.

From the measurement results of IR and ¹H-NMR, it was confirmed that the solid matter obtained in Example 6 was composed of a p-coumaric acid-caffeic acid random copolymer having a unit represented by the formula:

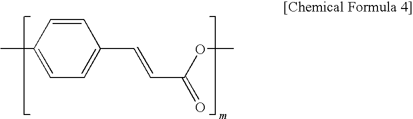

and a unit represented by the formula:

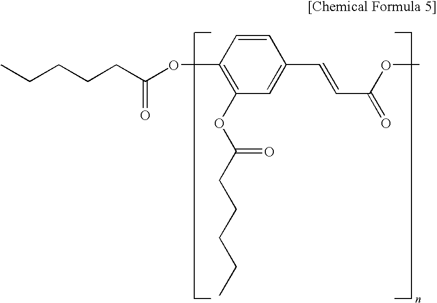

wherein the molar ratio of m to n (m/n) is 64/36. From the measurement result of ¹H-NMR, it was confirmed that the obtained p-coumaric acid-caffeic acid random copolymer had a number average molecular weight (Mn) of 10200, a weight average molecular weight (Mw) of 18600 and a molecular weight distribution (Mw/Mn) of 1.8.

### Example 7

### Production of Hard Foam of P-Coumaric Acid-Caffeic Acid Copolymer

The p-coumaric acid-caffeic acid copolymer obtained in Example 6 was heated at 200° C. for 1 hour. As a result, the copolymer softened. Although the appearance of the softened p-coumaric acid-caffeic acid copolymer was observed, the copolymer has not yet been foamed.

Thereafter, the softened p-coumaric acid-caffeic acid copolymer was filled into a mold having an internal shape of 50 mm in length, 6 mm in width and 7 mm in depth. At that time, the p-coumaric acid-caffeic acid copolymer could be easily filled into the mold because the copolymer was flexible. The p-coumaric acid-caffeic acid copolymer was compression-molded under a pressure of 5 MPa at a temperature of 200° C. for 20 minutes, followed by cooling to room temperature. Thereafter, the resulting molded article was taken out from the mold. When the surface of the molded article obtained was observed, voids or the like has not been formed and its appearance was beautiful.

When the obtained molded article was heated at a temperature of 220° C. for 1 hour in the air, the p-coumaric acid-caffeic acid copolymer foamed and its volume increased to about twice, so that a hard foam having an expansion ratio of about 2 times was obtained. The obtained hard foam had an average cell diameter of 15 μm. The gas generated during the production of the hard foam was examined by using a thermal decomposition gas chromatograph-mass spectrometer [commercial name: Clarus 500 GC/MS, manufactured by PerkinElmer Japan Co., Ltd.]. As a result, it was confirmed that the generated gas was hexanoic acid.

The obtained hard foam was cut with a knife and a scanning electron microscope (SEM) photograph of the cross section was taken. As a result, it was confirmed that many cells having pore diameters ranging from the order of nanometer to the order of millimeter are present in the obtained hard foam, as well as the hard foam obtained in Example 2.

As the physical properties of the obtained hard foam, mechanical strength (compressive strength) and heat resistance were examined in the same manner as in Example 2. As a result, it was confirmed that the compressive strength of the hard foam was 30 MPa, and the hard foam was excellent in heat resistance since no deformation or the like was observed in the hard foam even when the hard foam was exposed to an atmosphere having a high temperature of 300° C. for 12 hours.

From the above results, since the p-coumaric acid-caffeic acid copolymer can be heated to melt without foaming, it can be seen that a foam of a carboxylic acid ester-based polymer can be produced by heating the p-coumaric acid-caffeic acid copolymer to melt at a temperature lower than the boiling point of hexanoic acid, subsequently filling the molten copolymer into a mold, and heating the copolymer to a temperature equal to or higher than the boiling point of hexanoic acid.

From the above fact, a molded article free from the generation of voids can be produced by heating this p-coumaric acid-caffeic acid copolymer to melt and filling the molten copolymer into a mold, since the copolymer is molded without the formation of vacant spaces. Therefore, it can be seen that a hard foam can be produced by foaming this molded article.

Next, a brass line having a diameter of 1 mm was soldered to the surface of the obtained hard foam with lead-free solder (melting point: about 200° C.). As a result, the brass line was soldered to the hard foam without the generation of thermal deformation or the like, nevertheless the hard foam was made of a resin.

It can be seen from this fact that soldering can be easily applied to the hard foam obtained in Example 7, since the hard foam is not only excellent in heat resistance, but also has fine cells.

### Example 8

### Preparation of Ferulic Acid-Caffeic Acid Copolymer

Into a 500-mL separable flask were added 10 g of ferulic acid and 10 g of caffeic acid as monomers, 0.2 g of sodium phosphate as a catalyst and 20 g of acetic anhydride as an acetylating agent, which were then heated from room temperature to 190° C. under nitrogen gas flow, and were polymerized while being stirred with a mechanical stirrer. After heating and stirring the product for 2 hours from the commencement of the polymerization, the pressure in the flask was reduced to 1 kPa or lower by using a rotary pump, and the polymerization was carried out at 190° C. for additional 0.5 to 4 hours. The polymerization reaction was stopped when the resulting product solidified. Thereafter, a massive solid matter was obtained by cooling the resulting product.

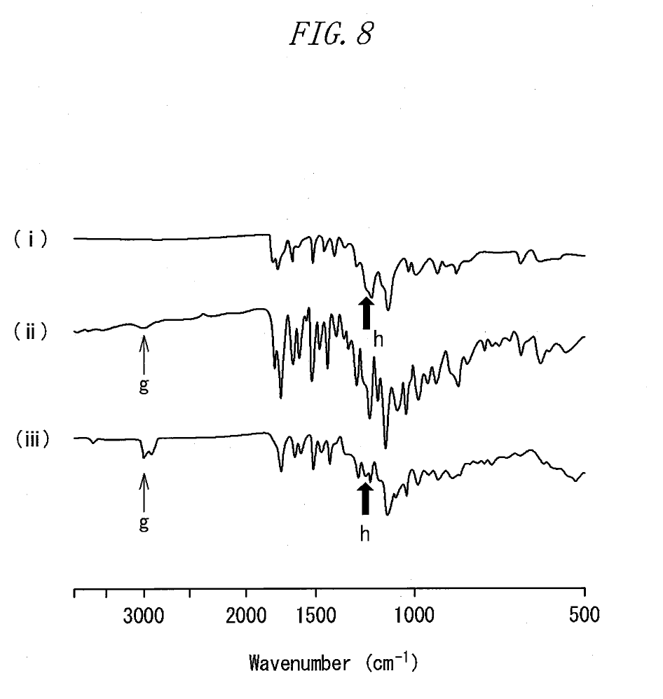

The infrared absorption spectrum (IR) of the obtained solid matter was examined by using an infrared absorption spectrometer (commercial name: Spectrum One, manufactured by PerkinElmer Co., Ltd.). The result is shown in FIG. 8.

In FIG. 8, (i) is an infrared absorption spectrum of poly(caffeic acid), (ii) is an infrared absorption spectrum of poly(ferulic acid), and (iii) is an infrared absorption spectrum of a ferulic acid-caffeic acid copolymer.

From the result shown in FIG. 8, it is confirmed that the obtained solid matter has a peak characteristic in ferulic acid (a peak based on a methyl group) represented by sign g and a peak characteristic in caffeic acid (a peak based on 1,2,4-trisubstituted benzene) represented by sign h.

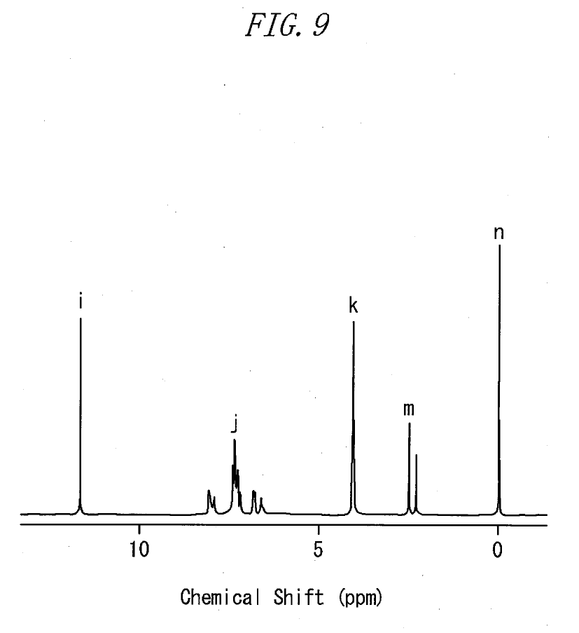

Moreover, the nuclear magnetic resonance (¹H-NMR) of the obtained solid matter was examined within the range of 13 to 0 ppm by using a nuclear magnetic resonance spectrometer (commercial name: Gemini-2000, manufactured by Varian, Inc.). The result is shown in FIG. 9. In FIG. 9, sign i represents a peak based on TFA (trifluoroacetic acid), sign j represents a peak based on phenylenevinylene, sign k represents a peak based on a methyl group of ferulic acid, sign m represents a peak based on an acetyl terminal group, and sign n represents a peak based on internal standard, TMS (tetramethylsilane).

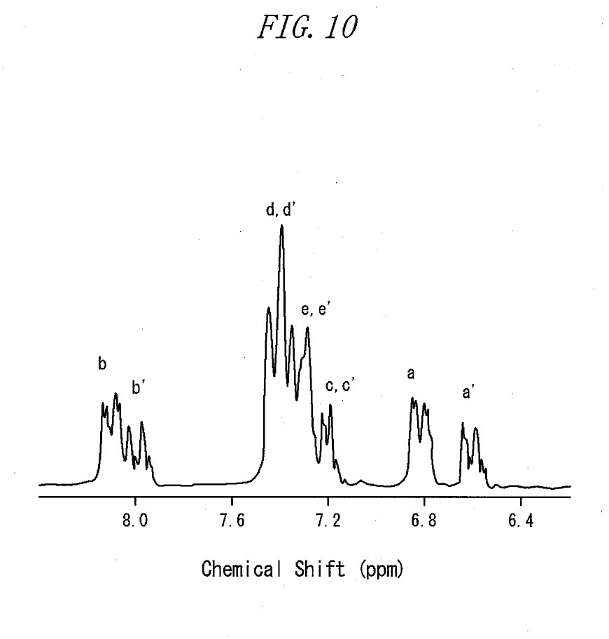

Next, the chemical shifts of the nuclear magnetic resonance (¹H-NMR) of the obtained solid matter within the range of 8.2 to 6.4 ppm are shown in FIG. 10. From the infrared absorption spectrum (IR) and the attribution of the peaks a, a′, b, b′, c, c′, d, d′, e, and e′ in the chemical shifts shown in FIG. 10, it was confirmed that the obtained solid matter was made of a ferulic acid-caffeic acid random copolymer composed of 33 mol % of the unit represented by the formula:

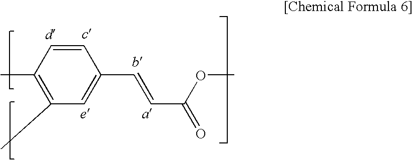

wherein signs each of a′, b′, c′, d′, and e′ represents the attribution of each peak shown in FIG. 10, respectively, and 67 mol % of the unit represented by the formula:

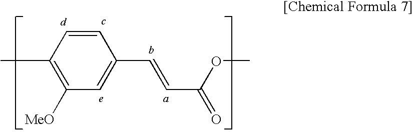

wherein each of signs a, b, c, d, and e represents the attribution of each peak shown in FIG. 10, respectively, and MeO represents a methoxy group, and that the obtained solid matter had an acetyloxy group at its terminal. Also, from the measurement result of ¹H-NMR, it was confirmed that the obtained ferulic acid-caffeic acid copolymer had a number average molecular weight (Mn) of 7100, a weight average molecular weight (Mw) of 8900 and a molecular weight distribution (Mw/Mn) of 1.3.

### Example 9

### Production of Hard Foam of Ferulic Acid-Caffeic Acid Copolymer

A hard foam was produced from the ferulic acid-caffeic acid copolymer obtained in Example 8 in the same manner as in Example 2. The obtained hard foam had an expansion ratio of 200 times and an average cell diameter of 15 μm. The hard foam was cut with a knife and a scanning electron microscope (SEM) photograph of the cross section was taken. As a result, it was confirmed that many cells having pore diameters ranging from the order of nanometer to the order of millimeter are present in the obtained hard foam, as well as the hard foam obtained in Example 2.

As the physical properties of the obtained hard foam, mechanical strength (compressive strength) and heat resistance were examined in the same manner as in Example 2. As a result, it was confirmed that the compressive strength of the hard foam was 30 MPa, and that the hard foam was excellent in heat resistance since no deformation or the like was observed in the hard foam even when the hard foam was exposed to the atmosphere having a high temperature of 300° C. for 12 hours. Also, the gas generated during the production of the hard foam was confirmed. As a result, it was confirmed that the gas generated was acetic acid.

Next, a brass line having a diameter of 1 mm was soldered to the surface of the obtained hard foam with lead-free solder (melting point: about 200° C.). As a result, the brass line was soldered to the hard foam without the generation of thermal deformation or the like, nevertheless the hard foam was made of a resin.

From this fact, it can be seen that soldering can be easily applied to the hard foam obtained in Example 9, since the hard foam is not only excellent in heat resistance, but also has fine cells.

### Example 10

### Preparation of Ferulic Acid-P-Coumaric Acid Copolymer

Into a 500-mL separable flask were added 10 g of ferulic acid and 10 g of p-coumaric acid as monomers, 20 g of acetic anhydride as an acetylating agent and 0.1 g of sodium phosphate as a catalyst, which were then heated from room temperature to 190° C. under a nitrogen gas flow, and were polymerized while being stirred with a mechanical stirrer. After heating and stirring the product for 2 hours from the commencement of the polymerization, the pressure in the flask was reduced to 1 kPa or lower by using a rotary pump, and the polymerization was carried out at 190° C. for additional 0.5 to 4 hours. The polymerization reaction was stopped when the resulting product solidified. Thereafter, a massive solid matter was obtained by cooling the resulting product.

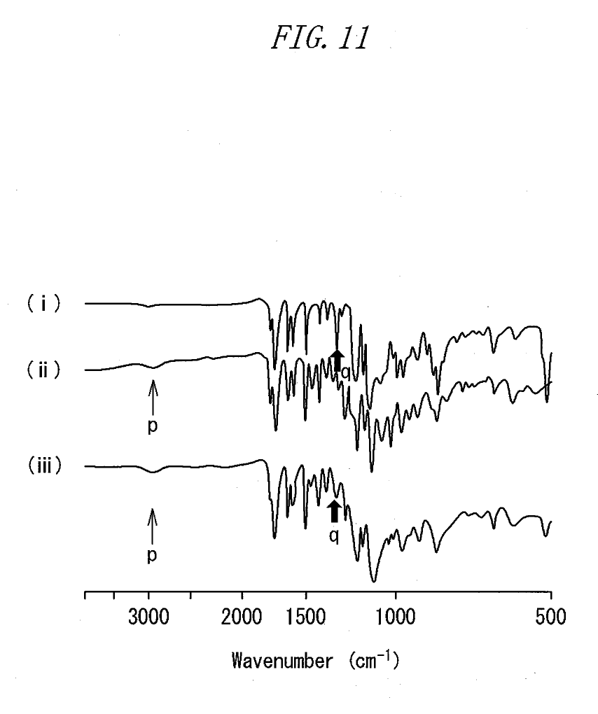

The infrared absorption spectrum (IR) of the obtained solid matter was examined by using an infrared absorption spectrometer (commercial name: Spectrum One, manufactured by PerkinElmer Co., Ltd.). The result is shown in FIG. 11.

In FIG. 11, (i) is an infrared absorption spectrum of poly(p-coumaric acid), (ii) is an infrared absorption spectrum of poly(ferulic acid), and (iii) is an infrared absorption spectrum of a ferulic acid-p-coumaric acid copolymer.

From the result shown in FIG. 11, it is confirmed that the obtained polymer has a peak characteristic in ferulic acid (a peak based on a methyl group) represented by sign p and a peak characteristic in p-coumaric acid (a peak based on a p-disubstituted benzene) represented by sign q.

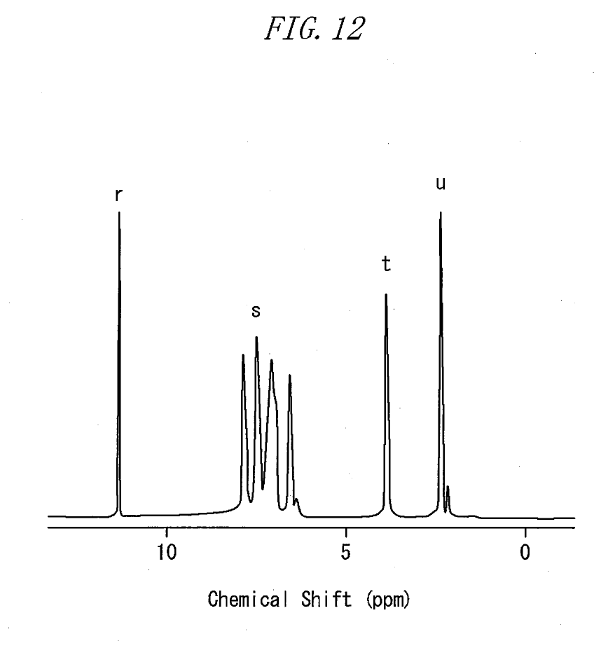

Moreover, the nuclear magnetic resonance (¹H-NMR) of the obtained solid matter was examined by using a nuclear magnetic resonance spectrometer (commercial name: Gemini-2000, manufactured by Varian, Inc.). The result is shown in FIG. 12. In FIG. 12, sign r represents a peak based on TFA (trifluoroacetic acid), sign s represents a peak based on phenylenevinylene, sign t represents a peak based on a methyl group of ferulic acid, and sign u represents a peak based on an acetyl terminal group.

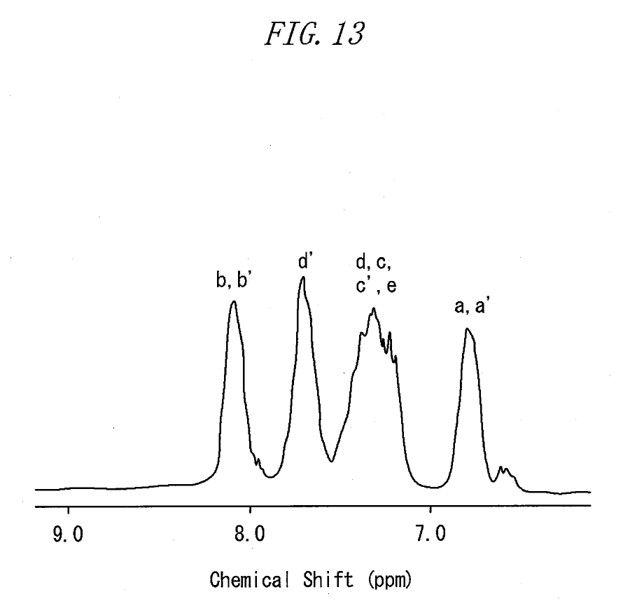

Next, the chemical shifts of the nuclear magnetic resonance (¹H-NMR) of the obtained solid matter within the range of 9.0 to 6.0 ppm are shown in FIG. 13. It was confirmed from the infrared absorption spectrum (IR) and the attribution of the peaks a, a′, b, b′, c, c′, d, d′, and e in the chemical shifts shown in FIG. 13 that the obtained solid matter was made of a ferulic acid-p-coumaric acid random copolymer composed of 57 mol % of the unit represented by the formula:

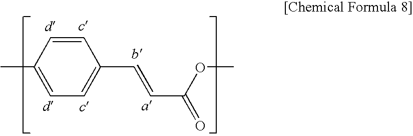

wherein each of signs a′, b′, c′, and d′ represents the attribution of each peak shown in FIG. 13, respectively and 43 mol % of the unit represented by the formula:

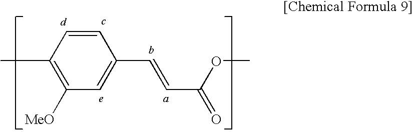

wherein each of signs a, b, c, d, and e represents the attribution of each peak shown in FIG. 13, respectively, and MeO represents a methoxy group, and that the solid matter had an acetyloxy group at a terminal. From the measurement result of ¹H-NMR, it was confirmed that the obtained ferulic acid-p-coumaric acid copolymer had a number average molecular weight (Mn) of 14900, a weight average molecular weight (Mw) of 51000 and a molecular weight distribution (Mw/Mn) of 3.4.

### Example 11

### Production of Hard Foam of Ferulic Acid-P-Coumaric Acid Copolymer

A hard foam was produced from the ferulic acid-p-coumaric acid copolymer obtained in Example 10 in the same manner as in Example 2. The obtained hard foam had an expansion ratio of 100 times and an average cell diameter of 10 μm. The hard foam was cut with a knife, and a scanning electron microscope (SEM) photograph of the cross section was taken. As a result, it was confirmed that many cells having pore diameters ranging from the order of nanometer to the order of millimeter were present in the obtained hard foam, as well as the hard foam obtained in Example 2.

As the physical properties of the obtained hard foam, mechanical strength (compressive strength) and heat resistance were examined in the same manner as in Example 2. As a result, it was confirmed that the compressive strength of the hard foam was 30 MPa, and that the hard foam was excellent in heat resistance, since no deformation or the like was observed in the hard foam even when the hard foam was exposed to an atmosphere having a high temperature of 300° C. for 12 hours. Also, the gas generated during the production of the hard foam was examined. As a result, it was confirmed that the gas generated was acetic acid.

Next, a brass line having a diameter of 1 mm was soldered to the surface of the obtained hard foam with lead-free solder (melting point: about 200° C.). As a result, the brass line was soldered to the hard foam without the generation of thermal deformation or the like, nevertheless the hard foam was made of a resin.

From this fact, it can be seen that soldering can be easily applied to the hard foam obtained in Example 11, since the hard foam is not only excellent in heat resistance, but also has fine cells.

### Experiment Example 1

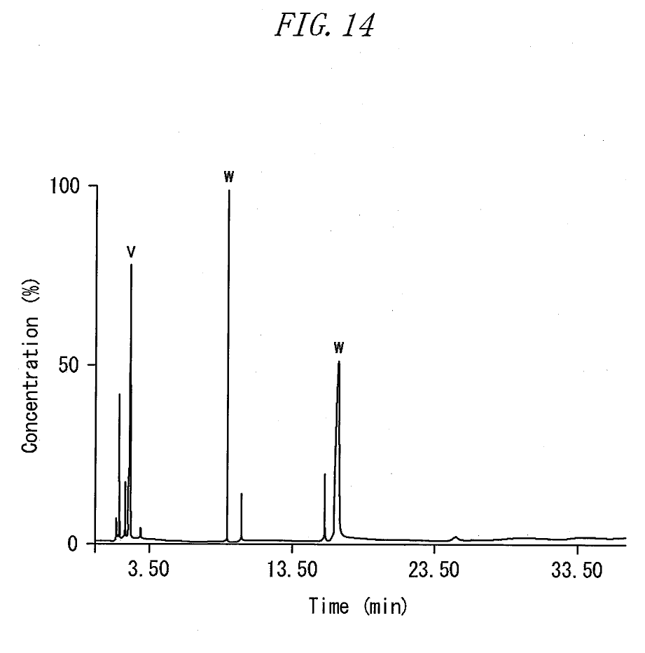

In helium gas atmosphere, 0.4 g of poly(ferulic acid) obtained in Example 1 was heated at a temperature of 200° C. for 5 minutes. The gas generated was cryotrapped with liquid nitrogen. After stopping the cooling, the gas generated was analyzed by gas chromatography (carrier gas: helium gas). The measurement result of the gas chromatography is shown in FIG. 14.

The gas chromatography was examined by using a thermal decomposition gas chromatograph-mass spectrometer [commercial name: Clarus 500 GC/MS, manufactured by PerkinElmer Japan Co., Ltd.], and the temperature was increased from 50° C. at a temperature increase rate of 10° C./min. When the temperature reached 320° C., the temperature was held for 10 minutes.

From the result shown in FIG. 14, it was confirmed that a peak v showing the presence of acetic acid was observed when about 2 minutes passed. This shows that acetic acid has been captured in poly(ferulic acid) obtained in Example 1. Moreover, a peak w showing the presence of an unreacted monomer was observed when about 9 minutes passed and when about 16.5 minutes passed.

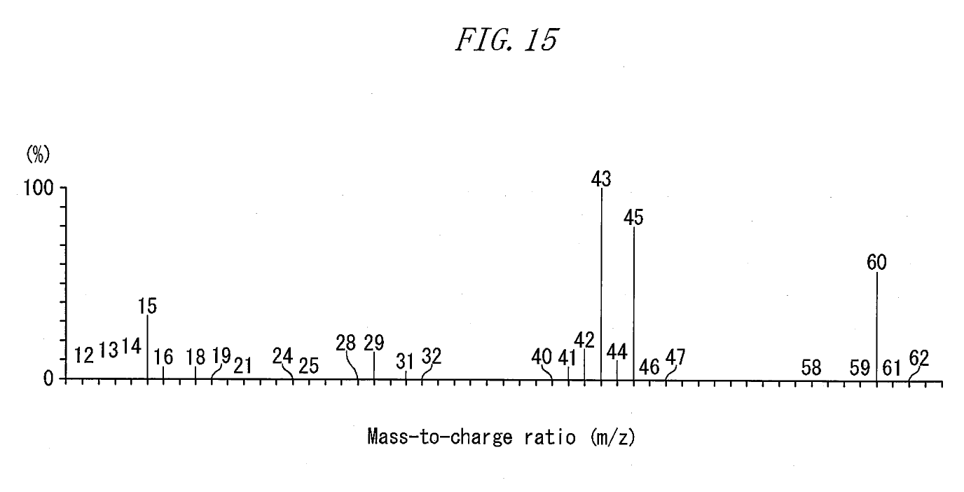

Next, when the elution time was about 2.26 minutes in the gas chromatography, an EI spectrum was measured by using a thermal decomposition gas chromatograph-mass spectrometer [built in Clarus 500 GC/MS (commercial name), manufactured by PerkinElmer Japan Co., Ltd.]. The measurement result of its EI spectrum is shown in FIG. 15.

It can be seen from the result shown in FIG. 15 that an ion having a molecular weight of 60 was detected as a precursor ion, and COOH⁺ (m/x: 45), CH₃CO⁺ (m/z: 43) and CH₃⁺ (m/z: 15) were detected as product ions. This shows that acetic acid has been captured in poly(ferulic acid) obtained in Example 1.

### Experiment Example 2

The electric resistance of the hard foams (cubic form of which one side length: 3 mm) of the carboxylic acid ester-based polymer obtained in each example was determined by using an LCR meter [Model No.: LCR-821, manufactured by Instek (GW INSTEK)]. As a result, the electric resistance of each foam was infinite. From this fact, it was confirmed that all of the obtained foams were excellent in insulating property.

### Experiment Example 3

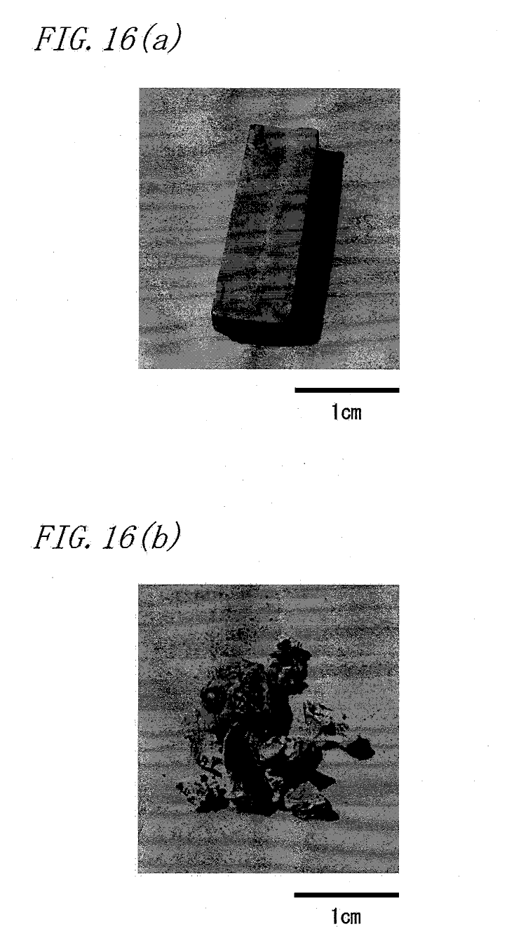

The hard foam of the ferulic acid-p-coumaric acid copolymer obtained in Example 11 was cut into a block of 3 mm in thickness, 5 mm in width and 30 mm in length, and the block was buried at a depth of 10 cm in the soil (alkaline black soil taken from the midslope of Mt. Aso, Nakadake), allowed to stand for 3 months, and thereafter took out from the soil. The result is shown in FIG. 16. In FIG. 16, (a) is an optical photograph of the hard foam before being buried in the soil, and (b) is an optical photograph of the hard foam after being buried in the soil for 3 months.

It can be seen from FIG. 16 that the hard foam of the present invention is decomposed only by being buried in the soil. Also, the mass of hard foam was determined before and after burying the hard foam in the soil. As a result, loss of weight of about 10% by mass was confirmed due to burying in the soil. This fact shows that the hard foam of the present invention is excellent in biodegradability.

### INDUSTRIAL APPLICABILITY

The hard foam of the present invention is excellent in heat resistance, and therefore is expected to be used, for example, in the surrounding of engines of automobiles, heaters, and central processing units (CPU) of computers. When the carboxylic acid ester-based polymer to be used as a raw material of the hard foam of the present invention has a (cyclo)alkanoyloxy group at a molecular end, the (cyclo)alkanoyloxy group is eliminated from the polymer upon heating, so that gas of an organic acid generates. Therefore, the carboxylic acid ester-based polymer can be suitably used by generating the organic acid gas from the polymer for neutralizing an atmosphere containing a basic substance such as ammonia or alkanoid.

Moreover, since the hard foam of the present invention is lightweight and has a sound insulation property, it is expected to be used as a soundproof material. Furthermore, since this foam has a vibration insulating property, it is expected to be used as a vibration isolator, and the like.

When a monomer which is derived from a plant, such as a polyphenol is used as a raw material monomer of the carboxylic acid ester-based polymer to be used as a raw material of the hard foam of the present invention, there are some advantageous merits such that the hard foam is excellent in environmental aspect, and that the carboxylic acid ester-based polymer itself has biodegradability. Among carboxylic acid ester-based polymers used as a raw material of the hard foam of the present invention, a polymer having resistance to oxidation is expected to be used as a freshness maintaining agent for food. Furthermore, among the carboxylic acid ester-based polymers, a polymer having antibacterial activity is expected to be used for trays for foods, and the like.

Since the hard foam of the present invention has a high electric insulating property, it is expected to be used for a film of electric circuits, and the like. The hard foam of the present invention which is excellent in adhesiveness to a material such as glass or metal has advantageous merits such that the hard foam can be easily bonded to these materials without the aid of an adhesive agent or a compatibilizing agent.

Accordingly, the hard foam of the present invention is expected to be used, for example, for automobile component materials, materials for airplanes, materials for the space field, materials for various industries, materials for medical assistance, and the like.

1. A hard foam formed from a carboxylic acid ester-based polymer having a ring structure, the hard foam being obtained by generating a gaseous organic acid from a carboxylic acid ester-based polymer having a ring structure by heating the carboxylic acid ester-based polymer, and foaming the heated carboxylic acid ester-based polymer with the gaseous organic acid.

2. The hard foam according to claim 1, wherein the carboxylic acid ester-based polymer is a carboxylic acid ester-based polymer comprising, as a structural unit, at least one unit selected from the group consisting of a unit represented by Formula (I): 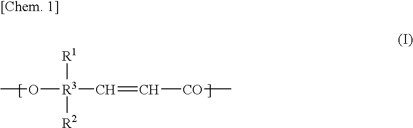
wherein R¹ and R² each independently represent a hydrogen atom, a hydroxyl group, a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms, and R³ represents an organic group having a ring structure, and a unit represented by Formula (II): 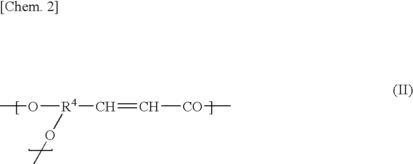
wherein R⁴ represents an organic group having a ring structure.

3. The hard foam according to claim 2, wherein in Formula (I), R¹ is a hydrogen atom, a hydroxyl group, a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms, and R² is a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms.

4. The hard foam according to claim 2, wherein in Formula (I), R¹ is a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms.

5. The hard foam according to claim 2, wherein in Formula (I), R¹ is a hydrogen atom or an alkoxy group having 1 to 12 carbon atoms, and R² is an alkoxy group having 1 to 12 carbon atoms.

6. The hard foam according to claim 2, wherein the unit represented by Formula (I) is a unit represented by Formula (Ia): 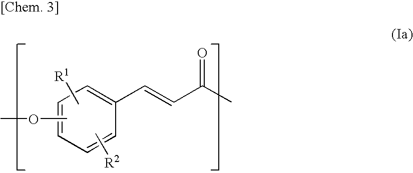
wherein R¹ and R² are the same as above.

7. The hard foam according to claim 2, wherein in Formula (II), R³ is an aromatic group having 5 to 12 carbon atoms, or an alicyclic group having 3 to 30 carbon atoms.

8. The hard foam according to claim 1 having, at a molecule end, a (cyclo)alkanoyloxy group having a boiling point that is higher than the softening temperature of the main chain.

9. The hard foam according to claim 1 containing, at a molecule end, a (cyclo)alkanoyloxy group that leaves and vaporizes at a temperature of 150° C. or lower.

10. The hard foam according to claim 1 having, at a molecule end, a (cyclo)alkanoyloxy group represented by Formula (IV):
R⁶O(CO)— (IV)
wherein R⁶ represents an alkyl group having 5 to 7 carbon atoms or an alicyclic group having 5 to 7 carbon atoms.

11. A method for producing a hard foam formed from a carboxylic acid ester-based polymer having a ring structure, which comprises generating a gaseous organic acid from a carboxylic acid ester-based polymer having a ring structure by heating the carboxylic acid ester-based polymer, and foaming the heated carboxylic acid ester-based polymer with the gaseous organic acid.

12. The method according to claim 11, wherein the carboxylic acid ester-based polymer is a carboxylic acid ester-based polymer comprising, as a structural unit, at least one unit selected from the group consisting of a unit represented by Formula (I): 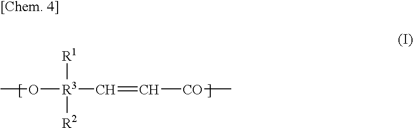
wherein R¹ and R² each independently represent a hydrogen atom, a hydroxyl group, a halogen atom, a thiol group, a carboxyl group, a pyridyl group, a phenyl group, a biphenyl group, a terphenyl group, a naphthyl group, an anthryl group, a phenanthryl group, a pentacenyl group, an alkyl group having 1 to 12 carbon atoms, an alicyclic group having 3 to 12 carbon atoms, an alkoxy group having 1 to 12 carbon atoms, an alkanoyl group having 1 to 12 carbon atoms, an alkanoyloxy group having 1 to 12 carbon atoms, an alkylthioether group having 1 to 12 carbon atoms, an alkenyl group having 2 to 12 carbon atoms, an alkynyl group having 2 to 12 carbon atoms, or a fluoroalkyl group having 1 to 12 carbon atoms, and R³ represents an organic group having a ring structure, and a unit represented by Formula (II): 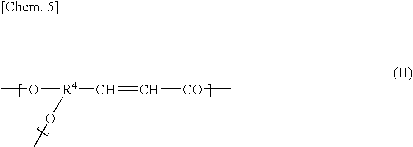
wherein R⁴ represents an organic group having a ring structure.

13. The method according to claim 12, wherein the unit represented by Formula (I) is a unit represented by Formula (Ia): 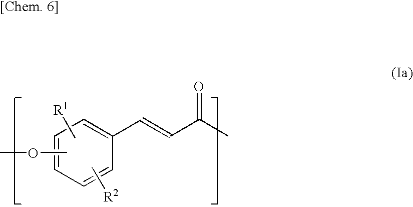
wherein R¹ and R² are the same as above.

14. The method according to claim 12, wherein in Formula (II), R³ is an aromatic group having 5 to 12 carbon atoms, or an alicyclic group having 3 to 30 carbon atoms.

15. The method according to claim 11 having, at a molecule end, a (cyclo)alkanoyloxy group having a boiling point that is higher than the softening temperature of the main chain.
